(19) United States
(12) Patent Application Publication
(10) Pub. No.: US 2009/0086266 A1
(43) Pub. Date: Apr. 2, 2009

(54) PRINTING SYSTEM AND PRINTING METHOD

(75) Inventor: Teruyoshi Nakashima, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 12/237,464

(22) Filed: Sep. 25, 2008

(30) Foreign Application Priority Data
Sep. 28, 2007 (JP) 2007-256765

(51) Int. Cl. G06F 3/12

(52) U.S. Cl. 358/1.15

(57) ABSTRACT

When a print job is interrupted in an in-store terminal due to an error, such as a paper jam and shortage of consumables, or user's instruction, the in-store terminal issues a resumption receipt on which identification information of the interrupted print job is printed. When the user inputs the identification information on the resumption receipt into another in-store terminal that is supposed to resume printing, resumption order information is downloaded from the in-store terminal to the other in-store terminal, thereby immediately resuming the interrupted print job.

### BACKGROUND OF THE INVENTION

1. Field of the Invention

The present invention relates to resumption of image printing that has been interrupted by an error or under an instruction from a user.

2. Description of the Related Art

The printing system in Japanese Patent Application Laid-Open No. 2005-189411 includes a photo printer having an exposure engine that performs print processing on paper and a terminal processor capable of accepting an order for print processing and controlling the photo printer to perform the print processing, and the photo printer and terminal processor are connected via a network. The terminal processor is provided with a monitoring unit for monitoring the operating status of the photo printer connected with the network. This monitoring unit includes a detection device that detects the occurrence of a situation requiring suspension or cancellation of the print processing of the photo printer and a determination device that determines whether or not the print processing should be transferred to another photo printer depending on the situation requiring suspension or cancellation.

According to Japanese Patent Application Laid-Open No. 2007-193580, an acceptance terminal obtains thumbnail image data from image data stored in a memory card. Order information, containing print size, the number of prints and so on, of an image selected by the user is temporarily stored. When the order is confirmed, the image data is retrieved from the memory card to be temporarily stored. When the order operation is suspended, the suspended order number is issued and the data that has been temporarily stored at the point of the suspension is stored, as a suspended order, in a DB (data base) section of an order management device. Upon resumption of the order operation, the suspended order, which is associated with the suspended order number input through the acceptance terminal, is retrieved from the DB section and transmitted to the acceptance terminal. Thus, thumbnail images are displayed and the order information is updated in accordance with the order operation.

### SUMMARY OF THE INVENTION

However, in the system of Japanese Patent Application Laid-Open No. 2005-189411, the terminal processor that automatically determines the transferability of the print process and a printer to which the print processing will be transferred provides a low degree of flexibility to users. In the case where this technique is applied to terminals in a store, once the terminal processor transfers the print process to an in-store terminal, the in-store terminal arbitrarily resumes printing, which is undesirable. On the other hand, the invention of Japanese Patent Application Laid-Open No. 2007-193580 cannot deal with suspension once a printing operation has started.

The present invention has an object to immediately resume the interrupted printing operation at any time desirable to the user.

To achieve the object, according to an aspect of the present invention, in a printing system in which a plurality of image printing terminals are connected via a network, among the plurality of image printing terminals, when a first image printing terminal, which has accepted order information specifying details of a desired image print, interrupts a print job based on the order information by an error or user's instruction while executing the print job, the first image printing terminal issues and outputs identification information associated with the interrupted print job. Further, a second image printing terminal among the plurality of image printing terminals, which receives the identification information, obtains data for executing the interrupted print job associated with the received identification information from the first image printing terminal, and resumes the interrupted print job.

In the printing system according to the aspect of the present invention, when the first image printing terminal that has accepted order information interrupts execution of the print job, the first image printing terminal issues and outputs identification information associated with the print job. When the user allows the second image printing terminal, which is supposed to resume printing, to obtain the identification information, the second image printing terminal then obtains data for executing the print job associated with the identification information from the first image printing terminal to resume the interrupted print job.

That is, when an image printing terminal that first accepted order information interrupts execution of the print job, the user moves to another image printing terminal so as to resume the interrupted print job immediately at any time with that image printing terminal.

In addition, since the user also has an option of waiting for the first image printing terminal to resume the print job without allowing the second image printing terminal to obtain the identification information, the user can select a terminal that can resume printing sooner than others depending on the occasion.

In the printing system, the first image printing terminal may select an image printing terminal appropriate for resumption of the interrupted print job from among the plurality of image printing terminals.

In the printing system, the first image printing terminal may select the image printing terminal according to the operational status of the plurality of image printing terminals or the remaining amount of consumables, and the amount of consumables required to execute the interrupted print job.

These selection criteria can prevent the consumables from running out again in the second image printing terminal.

In the printing system, the first image printing terminal may transmit to the selected image printing terminal reservation information for reserving the terminal for the print job. The image printing terminal that received the reservation information can accept only the instruction to resume printing.

This reservation information prevents the interrupted print job from being interrupted again by a print order made by another user.

In the printing system, when another image printing terminal other than the first image printing terminal is unavailable to execute the interrupted job, the first image printing terminal may output a notification to advise the user to wait for the first image printing terminal to resume printing, and when the other image printing terminal becomes available to execute the interrupted job, the first printing terminal may output a notification to advise the user to move to the other image printing terminal to resume the print job.

These notifications allow the user to readily judge whether or not the user should wait for the resumption of printing by the first image printing terminal to obtain a sooner resumption of printing.

In the printing system, prior to execution of the print job in accordance with the order information, the first image printing terminal may determine whether or not the first image printing terminal will suspend the print job according to the remaining amount of consumables if the print job is to be executed, and when it is determined that the print job will be suspended, the first image printing terminal may output a notification to advise the user to move to another image printing terminal to start the print job.

This allows the user to move to the image printing terminal that will not run out of consumables and therefore the user can avoid a reoccurrence of printing interruption. Since the order information has been already accepted by the first image printing terminal, the user does not need to input it again to the second image printing terminal.

In the printing system, the first image printing terminal may delete the order information and identification information if the second image printing terminal does not obtain the data for executing the interrupted print job before a predetermined period of time elapses.

Deleting the order information and identification information cleans up the data of the print job that has not been resumed even after a certain period of time.

According to an aspect of the present invention, in a printing system which a plurality of image printing terminals and a server are connected via a network, among the plurality of image printing terminals, when, among the plurality of image printing terminals, a first image printing terminal which has accepted order information specifying details of a desired image print, interrupts a print job based on the order information by an error or user's instruction while executing the print job, the server issues identification information associated with the interrupted print job, notifies the first image printing terminal of the identification information, obtains data for executing the interrupted print job from the first image printing terminal, and stores the identification information and the data for executing the interrupted print job associated therewith. And, the first image printing terminal outputs the identification information notified from the server. Further, a second image printing terminal, which obtains the identification information, obtains data for executing the interrupted print job associated with the obtained identification information from the server and resumes the interrupted print job.

In short, when an image printing terminal that first accepted order information is interrupted execution of the print job, the user moves to another image printing terminal so as to resume the interrupted print job immediately at any time with that image printing terminal.

In addition, since the user also has an option of waiting for the first image printing terminal to resume the print job without allowing the second image printing terminal to obtain the identification information, the user can select a terminal that can resume printing sooner than others depending on the occasion.

In the printing system, the server may select an image printing terminal appropriate for resumption of the interrupted print job from the plurality of image printing terminals.

In the printing system, the server may select the image printing terminal according to the operational status of the plurality of image printing terminals or the remaining amount of consumables, and the amount of consumables required to execute the interrupted print job.

In the printing system, the server may transmit to the selected image printing terminal reservation information for reserving the terminal for the print job, and the image printing terminal that received the reservation information can accept only the instruction to resume printing.

In the printing system, when another image printing terminal other than the first image printing terminal is unavailable to execute the interrupted job, the first image printing terminal may output a notification to advise the user to wait for the first image printing terminal to resume printing. And when the other image printing terminal becomes available to execute the interrupted job, the first printing terminal may output a notification to advise the user to move to the other image printing terminal to resume the print job.

In the printing system, prior to execution of the print job in accordance with the order information, the first image printing terminal may determine whether or not the first image printing terminal will suspend the print job according to the remaining amount of consumables if the print job is to be executed, and when it is determined that the print job will be suspended, the first image printing terminal may output a notification to advise the user to move to another image printing terminal to start the print job.

In any of the printing systems, the first image printing terminal can output the identification information with readable characters or bar code data.

The second image printing terminal can obtain the identification information through an input operation of the readable characters or acquisition of the bar code data.

The first image printing terminal can output the identification information on a predetermined display device or a piece of predetermined printable media.

According to an aspect of the present invention, a printing method used in a printing system in which a plurality of image printing terminals are connected via a network, the method includes the steps of: when a first image printing terminal among the plurality of image printing terminals, which has accepted order information specifying details of a desired image print, interrupts a print job based on the order information by an error or user's instruction while executing the print job, issuing identification information associated with the interrupted print job from the first image printing terminal; sending data for executing the interrupted print job associated with the received identification information, from the first image printing terminal to a second image printing terminal among the plurality of image printing terminals, which receives the identification information; and resuming the interrupted print job by the second image printing terminal.

According to an aspect of the present invention, a printing method used in a printing system in which a plurality of image printing terminals and a server are connected via a network, the method includes the steps of: when, a first image printing terminal among the plurality of image printing terminals, which has accepted order information specifying details of a desired image print, interrupts a print job based on the order information by an error or user's instruction while executing the print job, issuing identification information associated with the interrupted print job in the server; notifying the first image printing terminal of the identification information from the server; sending data for executing the interrupted print job from the first image printing terminal to the server; storing the identification information and the data for executing the interrupted print job associated therewith in the server; outputting the identification information notified from the server on output device of the first image printing terminal; and sending data for executing the interrupted print job associated with the received identification information, from the server to a second image printing terminal among the plurality of image printing terminals, which receives the identification information; and resuming the interrupted print job by the second image printing terminal.

In the aspects of the present invention, when an image printing terminal that first accepted order information is interrupted to execute the print job, the user moves to another image printing terminal so as to resume the interrupted print job immediately at any time with that image printing terminal.

In addition, since the user also has an option of waiting for the first image printing terminal to resume the print job without allowing the second image printing terminal to obtain the identification information, the user can select a terminal that can resume printing sooner than others depending on the occasion.

### BRIEF DESCRIPTION OF THE DRAWINGS

FIG. 1 is a schematic diagram of the printing system according to the first embodiment;

FIG. 2 is a front view of an in-store terminal;

FIG. 3 is a block diagram showing the hardware configuration of the in-store terminal;

FIG. 4 is a flow chart of the printing process according to the first embodiment;

FIG. 5 is an exemplary view of a normal print order reception screen;

FIG. 6 is an exemplary view of a print order reception screen when the in-store terminal is reserved;

FIGS. 7A and 7B are exemplary views of an identification code issuing screen when a print job is interrupted by an error and user's instruction, respectively;

FIG. 8 is an exemplary view of the identification code issuing screen when paper has run out;

FIG. 9 is an exemplary view of an identification information inputting screen (entry of the identification information via a key pad);

FIG. 10 is an exemplary view of an identification information inputting screen (entry of the identification information via bar code scanning);

FIG. 11 is an exemplary view showing the progress of the resumed printing process;

FIG. 12 is a schematic diagram of the printing system according to the second embodiment; and

FIG. 13 is a flow chart of the printing process according to the second embodiment.

### DETAILED DESCRIPTION OF THE PREFERRED EMBODIMENTS

### The First Embodiment

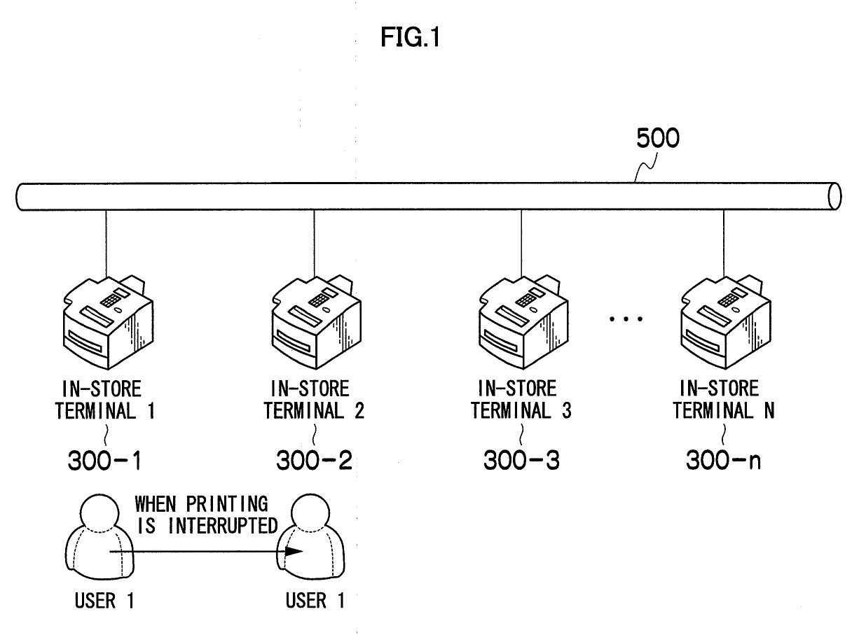

FIG. 1 is a schematic diagram of the printing system according to the preferred first embodiment of the present invention. This printing system comprises a plurality of in-store terminals 300 (300-1, 300-2 . . . 300-n) connected to a communication network 500 with a wire or wirelessly.

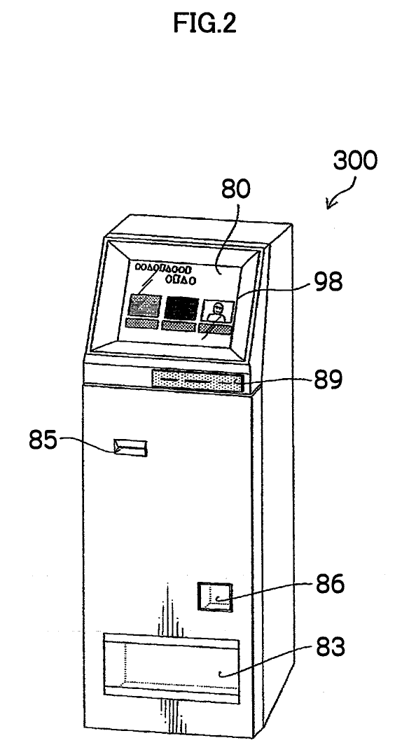

FIG. 2 is a front view of an in-store terminal 300 according to the present invention. This in-store terminal 300 is a machine for printing a digital image stored in a recording medium 50 (not shown), such as SmartMedia (trademark), on printable media after a user inserts the recording medium 50 into a loading slot 89 and inserts money. The in-store terminal 300 is an in-store information terminal installed in various types of retail stores such as a photo studio, book store and supermarket, and is usually used by a user who is trying to buy prints independently without the assistance of store clerks. In case of trouble in the in-store terminal 300, the user asks a clerk in the store where the in-store terminal 300 is installed or a special serviceperson to handle the trouble.

On the front surface of the in-store terminal 300, there is a liquid crystal display 80 with a touch panel 98 stacked thereon. The user operates the touch panel 98 while watching the display 80 to input information (order information) required to print images, such as selection of the image to be printed, print size, and the number of prints. The in-store terminal 300 includes a single or a plurality of printers 90 (not shown) that print out digital images. In the front of the outer surfaces of the in-store terminal 300, there are a chute 83 for ejecting printable media with an image printed thereon, a coin slot 85 through which coins are inserted to an undermentioned charging unit 88 and a coin return slot 86 through which the charging unit 88 returns change.

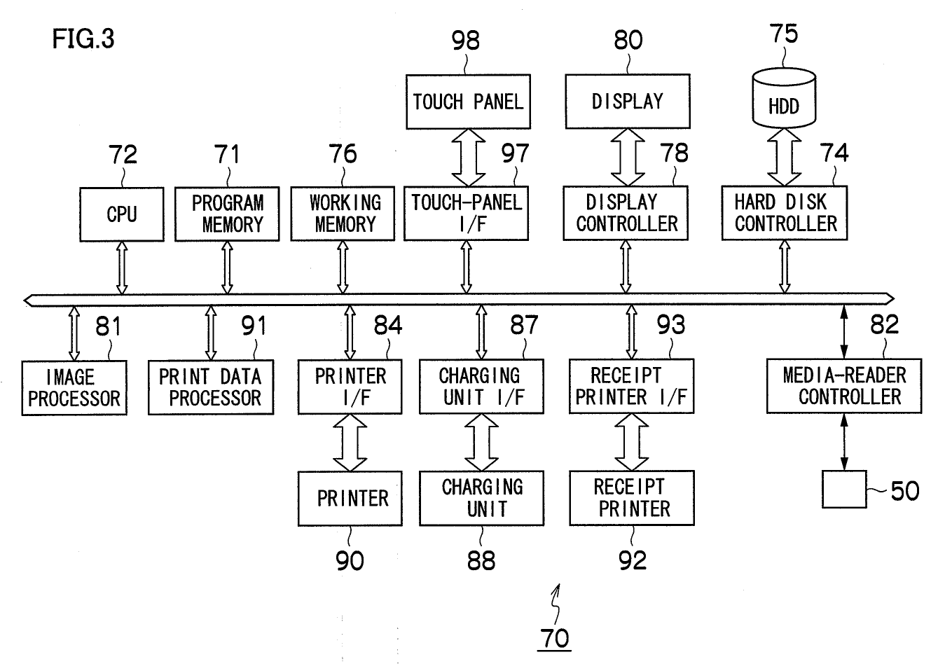

FIG. 3 is a block diagram showing the hardware configuration of the in-store terminal 300.

With the insertion of the recording medium 50 by a user into the media loading slot 89, the hard disk controller 74 loads control software stored in a hard disk (HDD) 75 into a program memory 71. A CPU 72 instructs a media-reader controller 82 to read out image data, which is stored in a predetermined compression format in the recording medium 50, to retrieve required image data from the recording medium 50. The retrieved image data is decompressed by an image processor 81 to return the image data to its original state, undergoes a predetermined image processing in the image processor 81 and is stored in a work memory 76. The image data can be obtained through infrared communication without using the recording medium 50.

By the user pressing desired positions of the touch panel 98, the necessary information, such as the print size and the number of prints, is converted into electrical signals corresponding to the pressed position and input into the CPU 72 through a touch-panel interface 97. The input information is displayed on the display 80. The display 80 is operated by a display controller 78. The charging unit 88 converts the amount of money that is displayed on the display 80 based on the information input through the touch panel 98 into an electrical signal and inputs it into the CPU 72 through a charging unit I/F 87. The CPU 72 checks whether the user has inserted the required money. If the required settlement amount has been inserted, a print data processor 91 creates print job data from the image data stored in the work memory 76 and sends the print job data via a printer I/F 84 to the printer 90. This series of control operations are performed by the CPU 72.

The receipt listing the amount of money inserted into the charging unit 88 and the amount of change returned to the user is output by a receipt printer 92. The details to be printed by the receipt printer 92 are specified by the CPU 72 via a receipt printer I/F 93.

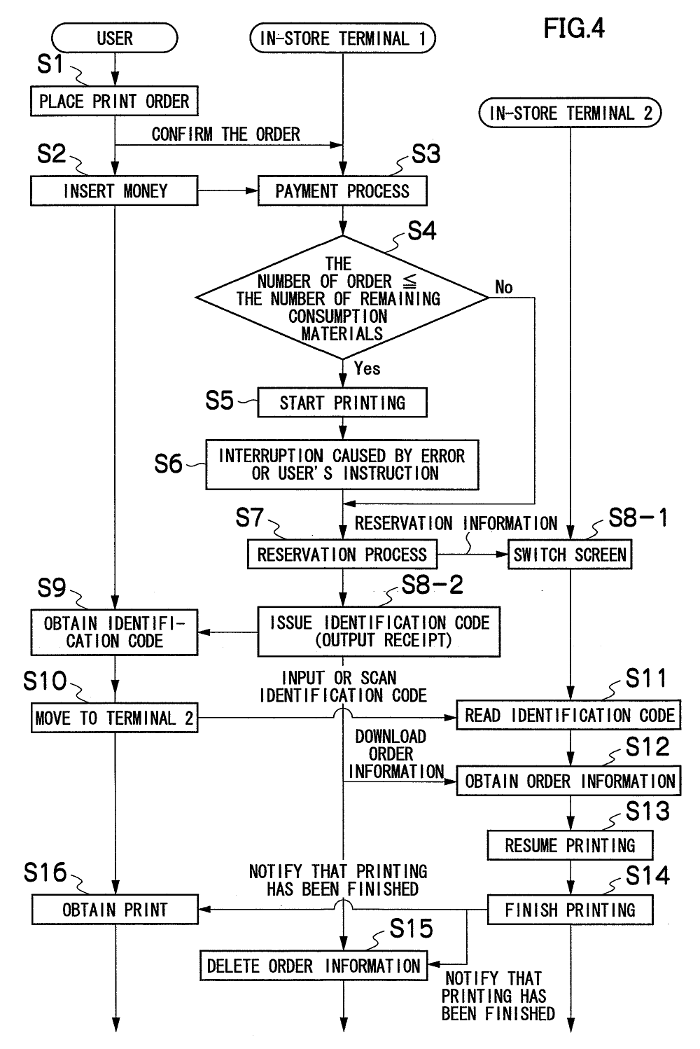

FIG. 4 illustrates the flow of the printing process performed by the printing system according to the first embodiment.

In S1, a user, who inserted a recording medium 50 into the media loading slot 89 of any one of the in-store terminals 300 (for the sake of convenience, the terminal is assumed to be the in-store terminal 300-1), operates the touch panel 98 while watching the display 80 to input necessary information (order information) such as desired images to be printed, print size and the number of prints. The in-store terminal 300-1 retrieves the desired image data from the recording medium 50 and displays the data on an order screen, while accepting the input order information and associating the confirmed order information with the images relating to the print order to store them in the HDD 75.

In S2, the user inputs the confirmation of the order information, for example by pressing the “OK” button. In response to the confirmation, the in-store terminal 300-1 starts the process of calculating the cost of the print order. The in-store terminal 300-1 displays on the display 80 a message urging the user to pay the required amount corresponding to the order information.

In S3, the in-store terminal 300-1 detects the money inserted into the charging unit 88. Then, the in-store terminal 300-1, if necessary, ejects the change into the coin return slot 86 to return it to the user and outputs from the receipt printer 92 a receipt listing the amount inserted into the charging unit 88, the amount returned to the user as change, and so on.

In S4, the in-store terminal 300-1 determines whether X number of prints in the order information is equal to or less than Y number of printable media pieces remaining in the printer 90 (i.e., whether the number of the remaining printable media pieces is adequate for the order). In the case of X≦Y (i.e., there are sufficient printable media pieces for the order), the process goes to S5. In the case of X>Y (i.e., there are not sufficient printable media pieces for the order), the process goes to S7.

Specifically, based on the determination of X>Y, the in-store terminal 300-1 can estimate in advance that implementation of the confirmed order will cause paper to run out and the print job will be interrupted and thus suggests the user to move to the in-store terminal 300-2 after the settlement process in S3 is completed. The in-store terminal 300-1 can notify, after determining X>Y, that the implementation of the confirmed order causes a shortage of paper, for example, by displaying a message, which helps the user avoid interruption of the print job due to the paper shortage before the interruption occurs. Since the order and settlement have been made before the user moves to the in-store terminal 300-2, the user does not need to make an order and payment with the in-store terminal 300-2 again.

In S5, upon completion of the settlement process, the in-store terminal 300-1 creates print job data based on the order information and sends the print job data to the printer 90.

In S6, the CPU 72 monitors if the printer 90 suspends the print job due to an error caused by an ink shortage, paper jam or other reasons or the instruction by the user for suspending the print. When interruption of the print job is detected, the process goes to S7.

In S7, the in-store terminal 300-1 selects one in-store terminal that will resume the interrupted print job from the in-store terminals 300-2 to 300-n. Specifically, the in-store terminal 300-1 inquires of the in-store terminals 300 via the network 500 whether they have more than Z number of the printable media pieces, which is obtained by subtracting N number of the already delivered prints from X number of the prints on order, and selects one optimal in-store terminal to resume printing from among the in-store terminals 300 which responded to the inquiry (e.g., one having the largest amount of remaining consumption materials, such as printable media and ink, than others, or the nearest one from the inquiring in-store terminal). In order to prevent paper from running out again, the next in-store terminal must have at least Z number of printable media pieces or more. The above selection prevents the user who moved to the in-store terminal from encountering a paper shortage again. For convenience in description, the in-store terminal 300-2 is assumed to be designated as an in-store terminal for resuming the interrupted print job.

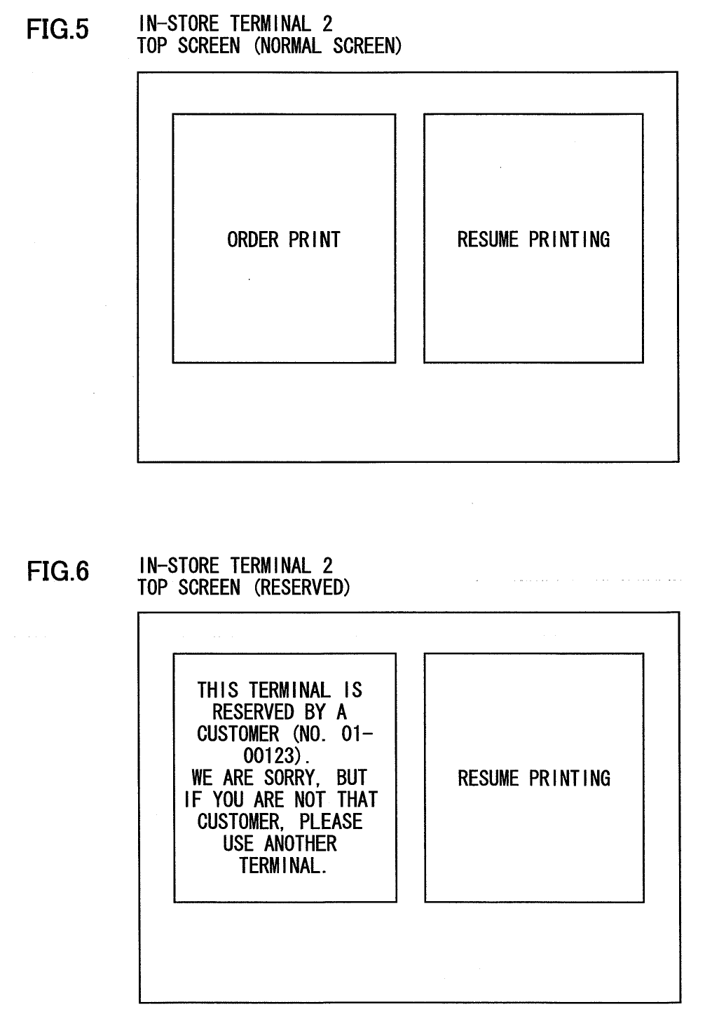

The in-store terminal 300-1 transmits to the in-store terminal 300-2 designated as the terminal for resuming the print job, reservation information for reserving the in-store terminal 300-2 so as to resume the print job. The in-store terminal 300-2 that received the reservation information switches its normal print order reception screen (see FIG. 5) to a screen with a button for accepting the resumption of the reserved print job (see FIG. 6) (S8-1). On the normal print order reception screen shown in FIG. 5, two buttons are available: an “order print” button for instructing the user to start a normal print order process; and a “resume printing” button for instructing the user to resume a printing process. On the reception screen for accepting the resumption of the print job shown in FIG. 6, the “resume printing” button can still be used, but the “order print” button has been cancelled, and a message stating that the in-store terminal is reserved is displayed.

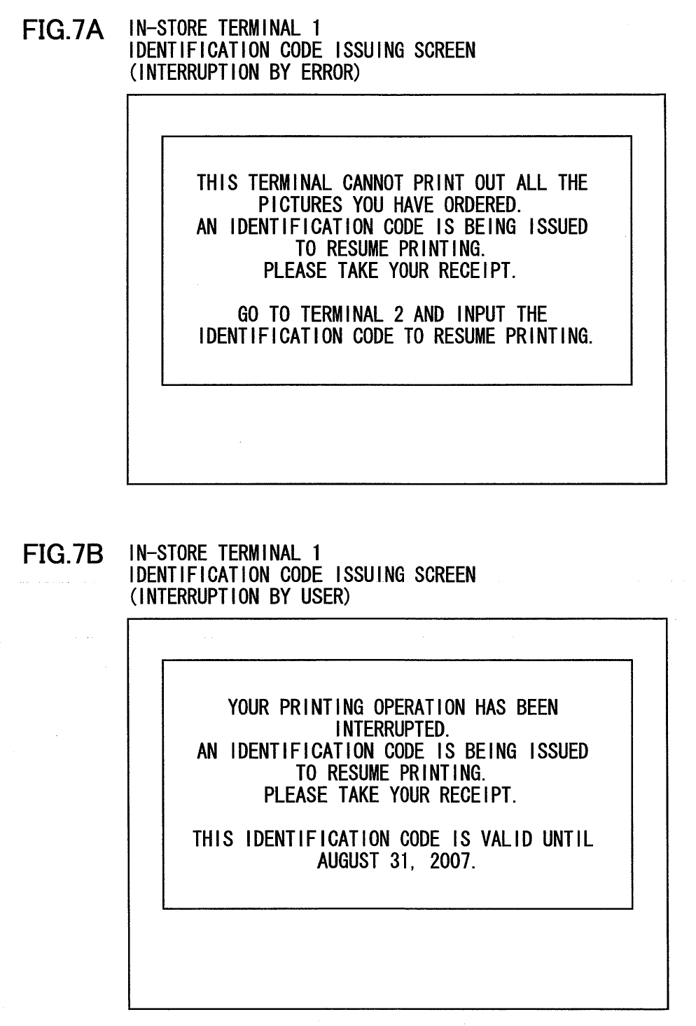

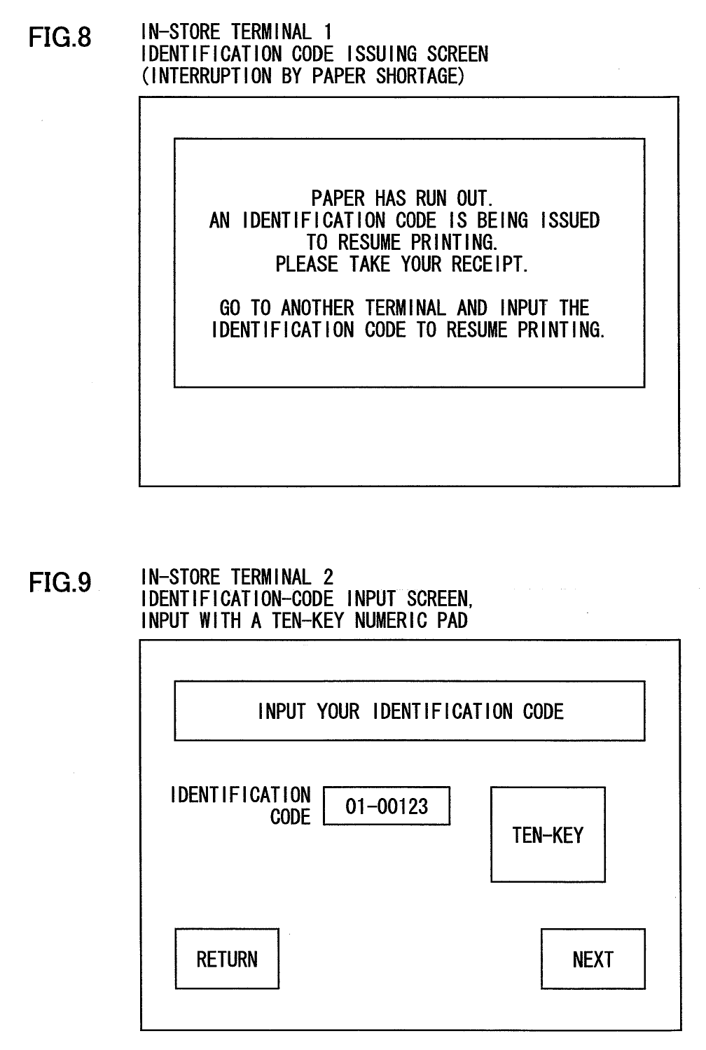

In S8-2, the in-store terminal 300-1 displays a message, on the display 80, stating that identification information of the interrupted print job is issued. As illustrated in FIGS. 7A and 7B, the description of the message can be changed according to the cause of the interruption of the print job such as an error in the in-store terminal 300-1 (FIG. 7A) and an instruction by the user (FIG. 7B). In errors causing interruption of a print job, a shortage of paper is more likely to happen and so the explicit indication of the paper shortage may be reasonable for the user, and therefore a window explicitly indicating that paper has run out may be displayed (FIG. 8). The other errors involving the complete consumption of ink or other consumable materials can be also explicitly indicated as well as the shortage of paper (not shown). When the in-store terminal for resuming printing is automatically selected, the number of the in-store terminal 300-2, which is the selected in-store terminal for resuming printing, can be indicated (FIG. 7A).

Simultaneously, the in-store terminal 300-1 displays on the display 80 a message stating that a receipt (resumption receipt) containing identification information of the interrupted print job is issued (FIG. 7 or 8), and outputs the resumption receipt from the receipt printer 92. The identification information can be printed out on the resumption receipt in any form. For example, the identification information can be printed out as letters, numeric symbols or other readable characters, or as a one-dimensional bar code or a two-dimensional bar code in which the identification information is embedded. Alternatively, the identification information can be encrypted.

In addition to the identification information, the resumption receipt may contain the number of the reserved in-store terminal 300-2 and user identification information (customer number). In this case, the in-store terminal 300-1 transmits the reservation information including the customer number to the in-store terminal 300-2, and then the in-store terminal 300-2 displays the customer number included in the received reservation information on the screen with a button for accepting the resumption of the reserved print job (see FIG. 6). With the aid of the displayed information, the user checks the customer number on the receipt against the customer number displayed on the display of the in-store terminal 300-2 to identify the in-store terminal 300-2 which is reserved to resume printing.

When the in-store terminal 300-2 that is selected as a terminal for resuming the print job is currently in operation, it may sometimes be sooner to wait for the in-store terminal 300-1 to resume the print job than to let the in-store terminal 300-2 resume the print job. In order to handle this situation, the in-store terminal 300-1, in the case where the in-store terminal 300-2 is currently working, displays a message advising the user to wait for the in-store terminal 300-1 to resume the print job instead of displaying the message stating the issue of the resumption receipt on the display 80, and if the in-store terminal 300-2 finishes its job, the in-store terminal 300-1 can display a message stating the issue of the resumption receipt on the display 80 at the point. This prevents the user from unnecessary movement between the terminals.

The in-store terminal 300-1 does not have to be the one to decide which in-store terminal resumes the interrupted print job, but the user can decide at his/her own will. In the case of allowing the user to freely select an in-store terminal to resume the print job, the in-store terminal 300 corresponding to the identification information inputted by the user is given priority to resume the print job, while the in-store terminal 300-2, which is selected by the in-store terminal 300-1 as an in-store terminal to resume the print job, is ignored. Alternatively, instead of executing the reservation process in S7, when the user makes the freely selected in-store terminal 300-x read the identification information, the in-store terminal 300-x that has read the identification information broadcasts a request to in-store terminals 300-y (x is different from y) to transmit the print job data associated with the read identification information. The in-store terminal 300-z that has the print job data associated with the identification information responds to the request and transmits the print job data to the in-store terminal 300-x. Thus, the user's discretion in selecting an in-store terminal for resuming printing is fully guaranteed.

In S9, the user takes the output resumption receipt.

In S10, the user moves with the resumption receipt to the in-store terminal 300-2 for resuming the print job and then presses the “resume printing” button (see FIG. 5 or 6).

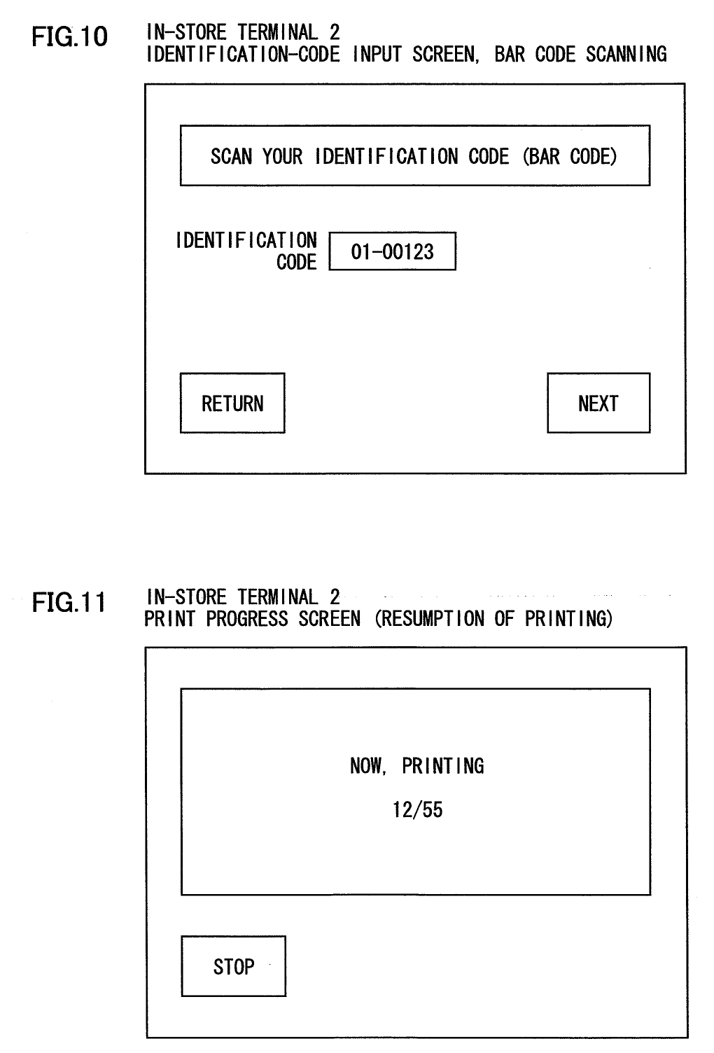

In S11, in response to the depression of the “resume printing” button, the in-store terminal 300-2 displays an identification-code input screen (see FIG. 9 or 10). The user inputs the readable identification information, for example “01-00123”, printed on the resumption receipt into the in-store terminal 300-2 through the identification-code input screen (FIG. 9). Alternatively, the in-store terminal 300-2 displays a screen that instructs the user to scan the identification information printed in the form of a one-dimensional bar code or two-dimensional bar code on the resumption receipt by using a bar-code reader of the in-store terminal 300-2 (FIG. 10) so that the user can input the identification information scanned by the bar-code reader.

In S12, the in-store terminal 300-2 notifies the in-store terminal 300-1, which transmitted the reservation information, of the identification information, which was input in S11, and requests the in-store terminal 300-1 to send the print job data associated with the identification information. The in-store terminal 300-1 transmits, as required, resumption order information including data for resuming the print job associated with the identification information to the in-store terminal 300-2 which then downloads the resumption order information. In the case where the in-store terminal 300-2 is selected by the user at his/her will to resume printing and has not received the reservation information, the in-store terminal 300-2 broadcasts the identification information to other in-store terminals 300 to request the transmission of the print job data associated with the identification information. Here, in this case, if the system is designed to issue unique identification information to every print job, it is possible to avoid the inconvenience such that the print job is redundantly downloaded from the plurality of in-store terminals 300 to the in-store terminal 300-2 for resuming the print job.

In the data of the print job created based on the order information input in S1, the resumption order information includes only data of the print job that has not been executed at the point of the interruption of print in S6. In this case, the in-store terminal 300-2 can resume the print job only by executing the printing process based on the received data of the print job. Alternatively, the resumption order information may include the entire order information input in S1 and a log indicating the time when the printing process was interrupted. In this case, the in-store terminal 300-2 creates data of the print job based on the received order information, extracts only job data after the point of the interruption that is indicated in the log, and resumes the job based on the job data. To put it briefly, the resumption order information can be anything as long as the resumption order information is in accordance with the details of the original order information and includes job data after the interruption.

The in-store terminal 300-2 stores the downloaded resumption order information in the HDD 75, or the like.

In S13, the in-store terminal 300-2 resumes the print job, which was interrupted in the in-store terminal 300-1, based on the obtained resumption order information. During the execution of the resumed print job, the in-store terminal 300-2 may display the progress of the print job on its screen (e.g., FIG. 11). If an error, such as a paper jam, occurs after the resumption, the in-store terminal 300-2 also can issue a resumption receipt in the same manner as the in-store terminal 300-1.

In S14, the in-store terminal 300-2 that completed the print job transmits a notification of the completion of the print job to the in-store terminal 300-1.

In S15, upon receipt of the notification of the completion of the print job, the in-store terminal 300-1 deletes the print job data and order information associated with the identification information transmitted from the in-store terminal 300-2.

In the case where the downloading process of the resumption order information is not executed even after a predetermined storage time has passed since the print interruption or the issue of the identification information, the in-store terminal 300-1 can delete the issued identification information and the order information associated therewith. In addition, in the case where the identification information is not inputted after the predetermined storage time has passed, the in-store terminal 300-2 may switch the order reception screen for reservation (FIG. 6) to the normal order reception screen (FIG. 5). These operations can clean up jobs that have not been accessed for a predetermined time and never resumed.

In S16, the in-store terminal 300-2 ejects prints to the chute 83 so that the user can obtain the remaining completed prints.

According to the above-described process, when the print job of the in-store terminal 300-1 is interrupted by a paper jam, shortage of consumables or other errors or user's instruction, a resumption receipt containing identification information of the interrupted print job (preferably including the identification information of the in-store terminal for resuming the print job and customer number) is issued. When the user inputs the identification information on the resumption receipt into the in-store terminal 300-2 which is supposed to resume the print job, the resumption order information is downloaded from the in-store terminal 300-1 to the in-store terminal 300-2, thereby resuming the interrupted print job immediately. Interruption caused by a shortage of consumables or paper jam requires the user to ask a clerk for assistance, which takes several minutes; however, the present process provides immediate resumption of the interrupted print job only by making the user move to an in-store terminal, which is freely selected by the user or reserved by the original in-store terminal, and input the identification information into the in-store terminal.

### The Second Embodiment

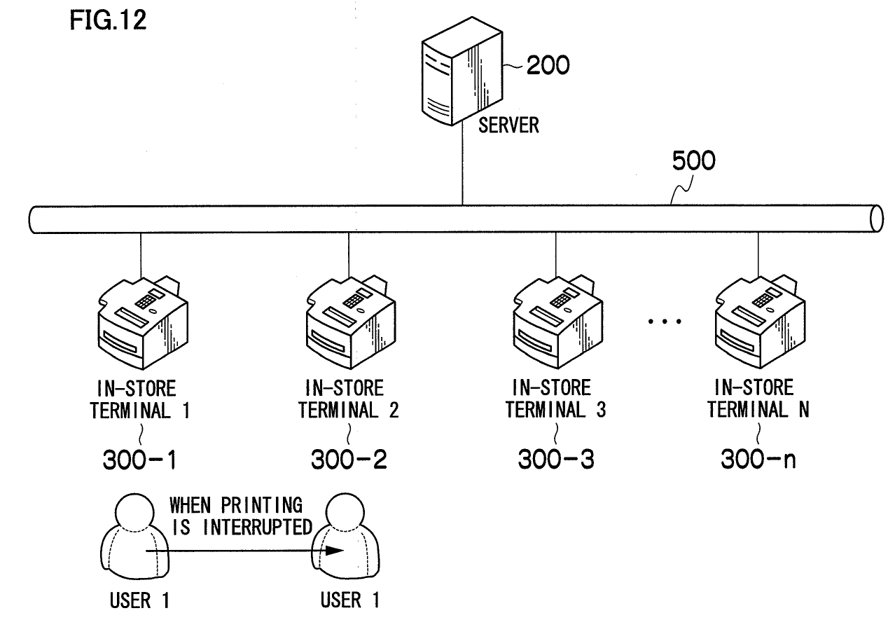

FIG. 12 is a schematic diagram of the printing system according to the preferred second embodiment of the present invention. This printing system includes a server 200 and a plurality of in-store terminals 300 (300-1, 300-2 . . . 300-n), all connected to a communication network 500.

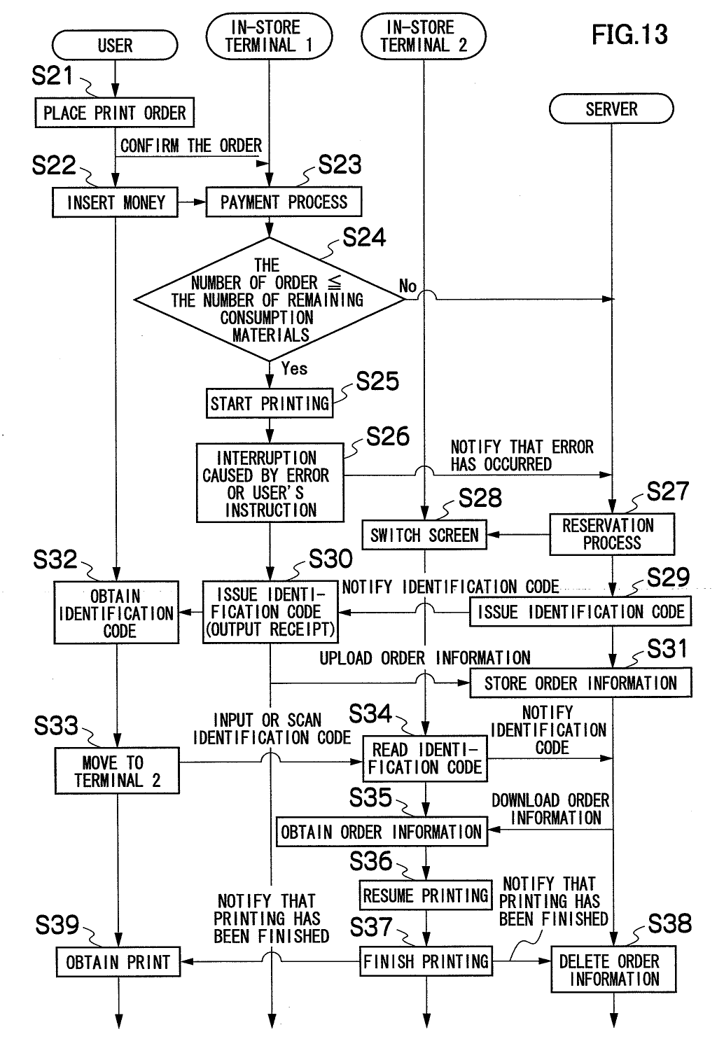

FIG. 13 illustrates a flow of the printing process executed in the printing system according to the second embodiment.

In S21, a user, who inserted a recording medium 50 into a media loading slot 89 of any one of the in-store terminals 300 (for the sake of convenience in illustration, the terminal is assumed to be the in-store terminal 300-1), operates the touch panel 98 while watching the display 80 to input necessary information (order information) such as desired images to be printed, print size and the number of prints. The in-store terminal 300-1 retrieves the desired image data from the recording medium 50 and displays the data on an order screen, while accepting the input order information and associating the confirmed order information with the images relating to the print order to store them in the HDD 75.

In S22, the user inputs the confirmation of the order information. In response to the confirmation, the in-store terminal 300-1 starts the process of calculating the cost of the print order. The in-store terminal 300-1 displays on the display 80 a message urging the user to pay the required amount corresponding to the order information.

In S23, the in-store terminal 300-1 detects the money inserted into a charging unit 88. Then, the in-store terminal 300-1, if necessary, ejects the change to a coin return slot 86 to return it to the user and outputs from the receipt printer 92 a receipt listing the amount inserted into the charging unit 88, the amount returned to the user as change, and so on.

In S24, the in-store terminal 300-1 determines whether X number of prints in the order information is equal or less than Y number of printable media pieces remaining in the printer 90. In the case of X≦Y, the process goes to S25. In the case of X>Y, the process goes to S27.

In S25, upon completion of the settlement process, the in-store terminal 300-1 creates print job data based on the order information and sends the print job data to the printer 90.

In S26, a CPU 72 of the in-store terminal 300-1 monitors if the printer 90 suspends the print job due to an error or user's instruction. When interruption of the print job is detected, the in-store terminal 300-1 notifies the server 200 of the detection, while requesting issue of identification information to resume the print job.

In S27, in response to the request from the in-store terminal 300-1, the server 200 selects one in-store terminal that will resume the interrupted print job from among the in-store terminals 300-2 to 300-n. The server 200 inquires of the in-store terminals 300 via the network 500 whether they have more than number Z of the printable media pieces, which is obtained by subtracting number N of the already delivered prints from number X of prints on order, and selects one optimal in-store terminal to resume printing from the in-store terminals 300 which responded to the inquiry. For convenience in description, the in-store terminal 300-2 is assumed to be designated as an in-store terminal for resuming the interrupted print job.

The server 200 transmits information for reserving the selected in-store terminal 300-2 to resume the print job to the in-store terminal 300-2.

In S28, the in-store terminal 300-2 that received the reservation information switches its normal print order reception screen (see, FIG. 5) to a screen with a button for accepting the resumption of the reserved print job (see, FIG. 6). The server 200 does not have to be the one to select the in-store terminal 300-2 as an in-store terminal for resuming printing, but the user can decide at his/her own will, as with the first embodiment.

In the case of allowing the user to freely select an in-store terminal to resume the print job, the in-store terminal 300 corresponding to the identification information inputted by the user is given priority to resume the print job, while the in-store terminal 300-2, which is selected by the server 200 as an in-store terminal to resume the print job, is ignored. Alternatively, instead of executing the reservation process in S27, when the user makes the freely selected in-store terminal 300-x read the identification information, the in-store terminal 300-x that has read the identification information requests the server 200 to transmit the print job data associated with the read identification information. In response to the request, the server 200 transmits the print job data associated with the identification information to the in-store terminal 300-x. Thus, the user's discretion in selecting an in-store terminal for resuming printing is fully guaranteed.

In S29, the server 200 issues identification information of the interrupted print job and notifies the in-store terminal 300-1 of the identification information. This identification information is unique for every print job of all in-store terminals 300.

In S30, upon receipt of the identification information transmitted from the server 200, the in-store terminal 300-1 displays a message, on the display 80, stating that the identification information has been issued.

Simultaneously, the in-store terminal 300-1 displays on the display 80 a message stating that a receipt (resumption receipt) containing the identification information of the interrupted print job is issued (FIG. 7 or 8), and outputs the resumption receipt from the receipt printer 92. As with the first embodiment, the identification information can be printed out in any form on the resumption receipt. In addition to the identification information, the resumption receipt may contain user identification information (customer number) of the user who reserved the in-store terminal 300-2.

When the in-store terminal 300-2 that is selected as a terminal for resuming the print job is currently in operation, it may sometimes be sooner to wait for the in-store terminal 300-1 to resume the print job than to let the in-store terminal 300-2 resume the print job. In order to handle this situation, the in-store terminal 300-1, in the case where the in-store terminal 300-2 is currently working, displays a message advising the user to wait for the in-store terminal 300-1 to resume the print job instead of displaying the message stating the issue of the resumption receipt on the display 80, and if the in-store terminal 300-2 finishes its job, the in-store terminal 300-1 can display a message stating the issue of the resumption receipt on the display 80 at the point. This prevents the user from unnecessary movement between the terminals.

Upon receipt of the identification information from the server 200, the in-store terminal 300-1 transmits resumption order information including the interrupted print job data to the server 20 and uploads the resumption order information. The details of the resumption order information are the same as that of the first embodiment. The server 200 associates the resumption order information obtained from the in-store terminal 300-1 with the associated identification information issued in S29 and stores the information (S31).

In S32, the user takes the resumption receipt output from the in-store terminal 300-1.

In S33, the user moves with the resumption receipt to the in-store terminal 300-2 for resuming the print job, and then presses the “resume printing” button (see FIG. 5 or 6).

In S34, in response to the depression of the “resume printing” button, the in-store terminal 300-2 displays an identification-code input screen (see FIG. 9). The user inputs the identification information, for example “01-00123”, printed on the resumption receipt into the in-store terminal 300-2 through the identification-code input screen. Alternatively, the in-store terminal 300-2 displays a screen that instructs the user to scan the identification information printed in the form of a one-dimensional bar code or two-dimensional bar code on the resumption receipt by using a bar-code reader of the in-store terminal 300-2 (FIG. 10) so that the user can input the identification information scanned by the bar-code reader.

In S35, the in-store terminal 300-2 notifies the identification information, which was input in S34, to the server 200 and requests the server 200 to transmit the print job data associated with the identification information. The server 200 transmits, as required, resumption order information associated with the identification information to the in-store terminal 300-2 which then downloads the resumption order information. The in-store terminal 300-2 stores the downloaded resumption order information in the HDD 75 or the like.

In S36, the in-store terminal 300-2 resumes printing based on the obtained resumption order information. During the execution of the resumed print job, the in-store terminal 300-2 may display the progress of the print job on its screen (e.g., FIG. 11). If an error, such as a paper jam, occurs in the in-store terminal 300-2 after the resumption of the print job, the server 200 can select a terminal for resuming printing again and notifies the in-store terminal 300-2. The identification information printed on the resumption receipt issued by the in-store terminal 300-1 can be used again. Since the identification information and the resumption order information are associated with each other and stored in the server 200, which is different from the first embodiment, any in-store terminal can identify the original job with the identification information, irrespective of which in-store terminal 300 was interrupted to print the job.

In S37, the in-store terminal 300-2 that completed the print job transmits a notification of the completion of print job to the server 200.

In S38, upon receipt of the notification of the completion of the print job, the server 200 deletes the resumption order information associated with the identification information transmitted from the in-store terminal 300-2.

In the case where the downloading process of the resumption order information is not executed even after a predetermined storage time has passed since the print interruption or the issue of the identification information, the in-store terminal 300-1 can delete the issued identification information and the order information associated therewith. In addition, the in-store terminal 300-2 into which the identification information has not been input after the above-mentioned predetermined storage time can switch the order reception screen for reservation (FIG. 6) to the normal order reception screen (FIG. 5).

In S39, the in-store terminal 300-2 ejects prints to the chute 83 so that the user can obtain the completed prints.

According to the above-described process, when the print job of the in-store terminal 300-1 is interrupted by a paper jam, shortage of consumables or other errors or user's instruction, the server 200 issues identification information of the interrupted print job. The in-store terminal 300-1 issues a resumption receipt listing the issued identification information of the print job and the identification information of the in-store terminal for resuming printing, while uploading resumption order information to the server 200. Input of the identification information on the resumption receipt, by the user, into the in-store terminal 300-2 which is supposed to resume the print job immediately resumes the interrupted print job. Interruption caused by a shortage of paper or paper jam requires the user to ask a clerk for assistance, which takes several minutes; however, the present process provides immediate resumption of the interrupted print job only by making the user move to an in-store terminal, which is freely selected by the user or reserved by the server 200, and input the identification information into the in-store terminal.

### Modification of the Embodiments

While embodiments of the present invention have been explained in detail, the present invention is not limited to the above examples, needless to say, various improvements and modifications may be added without departing from the scope of the present invention.

For example, in the embodiments, the users of in-store terminals pay printing expense in cash. However, the in-store terminals may be designed to deal with credit cards and electronic money such as Mobile IC Cards.

For example, in the embodiments, in case of allowing the user to freely select an in-store terminal to resume the print job, the user inputs the identification information of the in-store terminal 300 which the user wants to select at the in-store terminal which has interrupted the print job, and then the user goes to the selected in-store terminal. However, the user may directly go to the in-store terminal which the user wants to select, and input the identification information of the print job to be resumed at the selected in-store terminal.

What is claimed is:

1. A printing system in which a plurality of image printing terminals are connected via a network, wherein
among the plurality of image printing terminals:
when a first image printing terminal, which has accepted order information specifying details of a desired image print, interrupts a print job based on the order information by an error or user's instruction while executing the print job, the first image printing terminal issues and outputs identification information associated with the interrupted print job; and
a second image printing terminal, which receives the identification information, obtains data for executing the interrupted print job associated with the received identification information from the first image printing terminal, and resumes the interrupted print job.

2. The printing system according to claim 1, wherein
the first image printing terminal selects an image printing terminal appropriate for resumption of the interrupted print job from among the plurality of image printing terminals.

3. The printing system according to claim 2, wherein
the first image printing terminal selects the image printing terminal according to the operational status of the plurality of image printing terminals or the remaining amount of consumables, and the amount of consumables required to execute the interrupted print job.

4. The printing system according to claim 2, wherein
the first image printing terminal transmits to the selected image printing terminal reservation information for reserving the terminal for the print job, and
the image printing terminal which received the reservation information accepts only the instruction to resume printing.

5. The printing system according to claim 1, wherein
when another image printing terminal other than the first image printing terminal is unavailable to execute the interrupted job, the first image printing terminal outputs a notification to advise the user to wait for the first image printing terminal to resume printing, and
when the other image printing terminal becomes available to execute the interrupted job, the first printing terminal outputs a notification to advise the user to move to the other image printing terminal to resume the print job.

6. The printing system according to claim 1, wherein
prior to execution of the print job in accordance with the order information, the first image printing terminal determines whether or not the first image printing terminal will suspend the print job according to the remaining amount of consumables if the print job is to be executed, and
when it is determined that the print job will be suspended, the first image printing terminal outputs a notification to advise the user to move to another image printing terminal to start the print job.

7. The printing system according to claim 1, wherein
the first image printing terminal deletes the order information and identification information if the second image printing terminal does not obtain the data for executing the interrupted print job before a predetermined period of time elapses.

8. A printing system in which a plurality of image printing terminals and a server are connected via a network, wherein
when, among the plurality of image printing terminals, a first image printing terminal, which has accepted order information specifying details of a desired image print, interrupts a print job based on the order information by an error or user's instruction while executing the print job, the server issues identification information associated with the interrupted print job, notifies the first image printing terminal of the identification information, obtains data for executing the interrupted print job from the first image printing terminal, and stores the identification information and the data for executing the interrupted print job associated therewith,
the first image printing terminal outputs the identification information notified from the server, and
among the plurality of image printing terminals, a second image printing terminal, which obtains the identification information, obtains data for executing the interrupted print job associated with the obtained identification information from the server and resumes the interrupted print job.

9. The printing system according to claim 8, wherein
the server selects an image printing terminal appropriate for resumption of the interrupted print job from among the plurality of image printing terminals.

10. The printing system according to claim 9, wherein
the server selects the image printing terminal according to the operational status of the plurality of image printing terminals or the remaining amount of consumables, and the amount of consumables required to execute the interrupted print job.

11. The printing system according to claim 9, wherein
the server transmits to the selected image printing terminal reservation information for reserving the terminal for the print job, and
the image printing terminal that received the reservation information accepts only the instruction to resume printing.

12. The printing system according to claim 8, wherein
when another image printing terminal other than the first image printing terminal is unavailable to execute the interrupted job, the first image printing terminal outputs a notification to advise the user to wait for the first image printing terminal to resume printing, and
when the other image printing terminal becomes available to execute the interrupted job, the first printing terminal outputs a notification to advise the user to move to the other image printing terminal to resume the print job.

13. The printing system according to claim 8, wherein
prior to execution of the print job in accordance with the order information, the first image printing terminal determines whether or not the first image printing terminal will suspend the print job according to the remaining amount of consumables if the print job is to be executed, and
when it is determined that the print job will be suspended, the first image printing terminal outputs a notification to advise the user to move to another image printing terminal to start the print job.

14. The printing system according to claim 1, wherein
the first image printing terminal outputs the identification information with readable characters or bar code data.

15. The printing system according to claim 14, wherein
the second image printing terminal obtains the identification information through an input operation of the readable characters or acquisition of the bar code data.

16. The printing system according to claim 1, wherein
the first image printing terminal outputs the identification information on a predetermined display device or a piece of predetermined printable media.

17. A printing method used in a printing system in which a plurality of image printing terminals are connected via a network, the method comprising the steps of:
when a first image printing terminal among the plurality of image printing terminals, which has accepted order information specifying details of a desired image print, interrupts a print job based on the order information by an error or user's instruction while executing the print job, issuing identification information associated with the interrupted print job from the first image printing terminal;
sending data for executing the interrupted print job associated with the received identification information, from the first image printing terminal to a second image printing terminal among the plurality of image printing terminals, which receives the identification information; and
resuming the interrupted print job by the second image printing terminal.

18. A printing method used in a printing system in which a plurality of image printing terminals and a server are connected via a network, the method comprising the steps of:
when, a first image printing terminal among the plurality of image printing terminals, which has accepted order information specifying details of a desired image print, interrupts a print job based on the order information by an error or user's instruction while executing the print job, issuing identification information associated with the interrupted print job in the server;
notifying the first image printing terminal of the identification information from the server;
sending data for executing the interrupted print job from the first image printing terminal to the server;
storing the identification information and the data for executing the interrupted print job associated therewith in the server;
outputting the identification information notified from the server on output device of the first image printing terminal; and
sending data for executing the interrupted print job associated with the received identification information, from the server to a second image printing terminal among the plurality of image printing terminals, which receives the identification information; and
resuming the interrupted print job by the second image printing terminal.
